(19) United States
(12) Patent Application Publication
(10) Pub. No.: US 2013/0153160 A1
(43) Pub. Date: Jun. 20, 2013

(54) SUNSHADE ASSEMBLY

(71) Applicant: MACAUTO INDUSTRIAL CO., LTD., Tainan City (TW)

(72) Inventor: Paul Lin, Tainan City (TW)

(73) Assignee: MACAUTO INDUSTRIAL CO., LTD., Tainan City (TW)

(21) Appl. No.: 13/671,766

(22) Filed: Nov. 8, 2012

Related U.S. Application Data
(63) Continuation-in-part of application No. 13/606,467, filed on Sep. 7, 2012.

(30) Foreign Application Priority Data
Nov. 18, 2011 (TW) 100142292
Dec. 8, 2011 (TW) 100223155

(51) Int. Cl. E06B 9/42; E06B 9/58

(52) U.S. Cl. CPC E06B 9/42; E06B 9/58
USPC 160/267.1

(57) ABSTRACT

A sunshade assembly includes a winding shaft, a sunshade curtain wound around the winding shaft, a pull rod connected to the sunshade curtain end distal from the winding shaft, and two guide rail units. Each guide rail unit includes a longitudinal rack member in a direction transverse to the winding shaft. A link unit includes a connecting shaft and two pinion gears respectively attached to the connecting shaft and meshed with the rack members. A resistance unit includes a base mounted to the pull rod and frictionally contacting the connecting shaft to provide a resisting force against rotation of the connecting shaft.

### CROSS-REFERENCE TO RELATED APPLICATION

This application is a continuation-in-part of U.S. patent application Ser. No. 13/606,467 (hereinafter referred to as the '467 application). The '467 application, entitled “Sunshade Assembly,” was filed on Sep. 7, 2012 and claims priority of Taiwanese Application no. 100223155, filed on Dec. 8, 2011. This application claims priority of Taiwanese Application No. 100142292, filed on Nov. 18, 2011.

### BACKGROUND OF THE INVENTION

1. Field of the Invention

The invention relates to a sunshade assembly, and more particularly to a sunshade assembly having pinion gears meshed with rack members and adapted for placement on an inside surface of a window of a vehicle or a building.

2. Description of the Related Art

Currently, there are various types of sunshade assemblies sold on the market, wherein a conventional track type sunshade assembly has two guide rails respectively disposed on two lateral sides of a sunshade curtain. In use, the sunshade curtain can be extended or retracted along the two guide rails. In order to adjust a sun shading area, manufacturers currently have developed various structures that allow users to freely pull and stop the sunshade curtain at any desired extended position so as to flexibly adjust an extent of sun shading. However, when the sunshade curtain is extended, the conventional sunshade assembly is limited by the structural design thereof, and thus, it is required to apply a pull force to the sunshade curtain at a central position of a free end of the sunshade curtain so as to smoothly extend the sunshade curtain along the guide rails. If the pull force is applied at a position deviating from the central position of the free end of the sunshade curtain, the pull force will be unevenly applied to the sunshade curtain, and the sunshade curtain tends to be obliquely taken up or stuck between the guide rails. Thus, the smoothness of take-up and extension of the sunshade curtain will be adversely influenced, and at the worst, extension of the sunshade curtain may not be possible, thereby causing inconvenience to users.

### SUMMARY OF THE INVENTION

Therefore, an object of the present invention is to provide a sunshade assembly that can alleviate at least one of the aforesaid drawbacks of the prior art.

According to the present invention, a sunshade assembly includes two spaced-apart mounting seats, a winding shaft, a sunshade curtain, a pull rod, two guide rail units, a link unit, and a resistance unit. The winding shaft is mounted rotatably between the mounting seats. The sunshade curtain is extendably wound around the winding shaft. The pull rod is connected to one end of the sunshade curtain that is distal from the winding shaft. Each of the guide rail units includes a longitudinal rack member in a direction transverse to the winding shaft. The link unit includes a connecting shaft that is mounted rotatably to the pull rod and that has two opposite ends, and two pinion gears that are respectively attached to the two opposite ends of the connecting shaft and meshed with the rack members of the guide rail units. The resistance unit includes a base mounted to the pull rod and frictionally contacting the connecting shaft to provide a resisting force against rotation of the connecting shaft.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view to illustrate the preferred embodiment of a sunshade assembly according to the present invention in a take-up state;

FIG. 2 is an enlarged fragmentary perspective view illustrating cooperation among a link unit, a guide rail unit and a pull rod of the preferred embodiment of FIG. 1;

FIG. 3 is an enlarged fragmentary exploded view illustrating engagement between a resistance unit and the pull rod of the preferred embodiment of FIG. 1;

FIG. 4 is an enlarged fragmentary sectional view illustrating assembly of the pull rod, the resistance unit and the link unit of the preferred embodiment of FIG. 1; and

FIG. 5 is a schematic view similar to FIG. 1 to illustrate the sunshade assembly of the preferred embodiment in an extended state.

### DETAILED DESCRIPTION OF THE PREFERRED EMBODIMENT

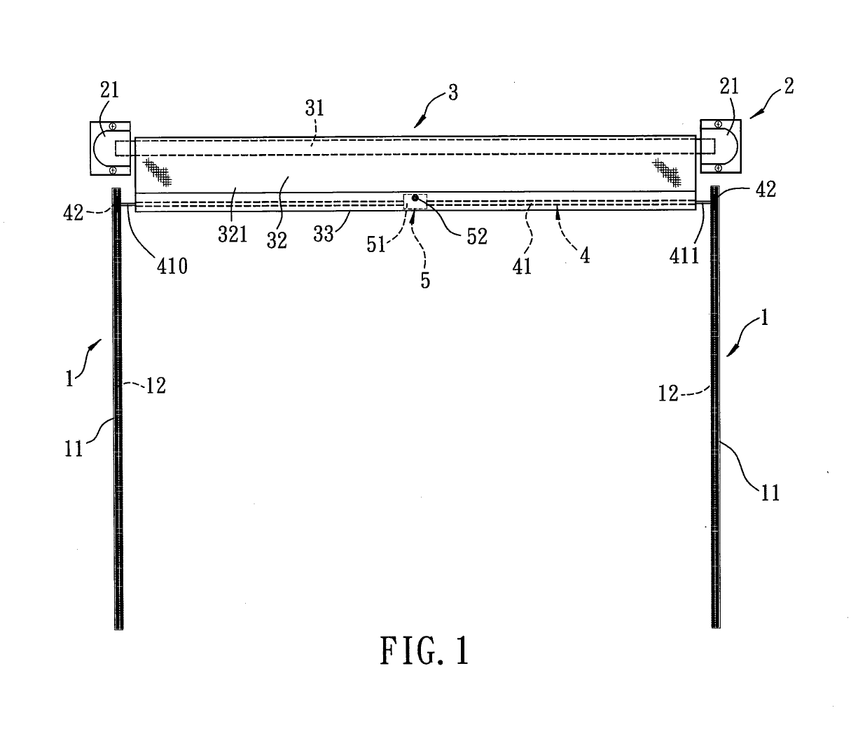

Referring to FIGS. 1 to 3, the preferred embodiment of a sunshade assembly according to the present invention is illustrated. The sunshade assembly is adapted to be installed on an inside surface of a window of a vehicle or a building. In this embodiment, the sunshade assembly is to be disposed under a roof of the vehicle (not shown) for covering a sunroof. Alternatively, the sunshade assembly may be disposed on an inside surface of a vehicle door for covering a side window. Thus, the arrangement position and direction of the sunshade assembly according to the present invention can be adjusted based on an intended applied situation and are not limited to this preferred embodiment.

In this preferred embodiment, the sunshade assembly includes amounting unit 2, a sunshade unit 3, two guide rail units 1, a link unit 4, and a resistance unit 5.

The mounting unit 2 includes two spaced-apart mounting seats 21. Alternatively, the two mounting seats 21 may be integrally formed. Since the feature of this invention does not reside in the configuration of the mounting seats 21, which may be readily appreciated by those skilled in the art, details of the same are omitted herein for the sake of brevity.

The sunshade unit 3 includes a winding shaft 31 rotatably mounted between the mounting seats 21, a sunshade curtain 32 extendably wound around the winding shaft 31, and a pull rod 33 connected to one end 321 of the sunshade curtain 32 that is distal from the winding shaft 31. Preferably, the pull rod 33 is a hollow rod and extends along the width direction of the sunshade curtain 32. Preferably, the sunshade unit 3 further includes at least one resilient member (not shown) having two opposite ends. One of the opposite ends is fixed and the other of the opposite ends is connected to the winding shaft 31 so that the resilient member provides a resilient force to drive rotation of the winding shaft 31 to have a. tendency towards the take-up state, i.e., the sunshade curtain 32 tends to be wound around the winding shaft 31 without an applied force.

In this embodiment, each of the guide rail units 1 includes a longitudinal rack member 12 extending in a direction transverse to the winding shaft 31. Preferably, each of the guide rail units 1 further includes an elongate frame 11 of substantially U-shaped cross section that has a main wall 111, and two opposite sidewalls 112 extending transversely and respectively from two opposite ends of the main wall 111 towards the other one of the guide rail units 1. The main wall 111 and the sidewalls 112 of each guide rail unit 1 cooperatively define a rail groove 113 having an opening end. The opening ends of the rail grooves 113 of the two guide rail units 1 face each other. The rack member 12 is longitudinally disposed on one of the sidewalls 112 and has a plurality of rack teeth 121. Alternatively, the frame 11 and the rack member 12 of each of the guide rail units 1 may be integrally formed.

The link unit 4 includes a connecting shaft 41 mounted rotatably in the pull rod 33 and having two opposite ends 410, 411, and two pinion gears 42 respectively attached to the two opposite ends 410, 411 of the connecting shaft 41 and respectively meshed with the rack members 12. The connecting shaft 41 is movable together with the pull rod 33 along the rack members 12. Each of the pinion gears 42 has a plurality of gear teeth 421 respectively meshing with the rack teeth 121 of a corresponding one of the rack members 12. The pinion gears 42 are together rotatable with the connecting shaft 41 and are simultaneously moveable backward and forward along the rack members 12. By engagement between the gear teeth 421 and the rack teeth 121, the pinion gears 42 can simultaneously and stably move on the rack members 12 and the connecting shaft 41 can be moved parallel with and relative to the winding shaft 31 without swerving, thereby controlling a backward and forward moving distance of the pull rod 33 relative to the winding shaft 31. Preferably, each of the pinion gears 42 may be made of a flexible material selected from the group consisting of silicone, rubber and combinations thereof, while each of the rack members 12 may be made from a material having a hardness higher than that of the flexible material, such as plastic. Alternatively, each of the rack members 12 may be made of the flexible material and each of the pinion gears 42 may be made of the material having the hardness higher than that of the flexible material. The choices of the materials for making the pinion gears 42 and the rack members 12 preferably complement each other, thereby reducing noise and providing a frictional resistance force when the sunshade curtain 32 is adjusted. However, actual implementation is not limited in this respect.

In this embodiment, the resistance unit 5 is disposed in the pull rod 33, which is formed into a hollow rod, and includes a base 51 and a fastener 52. The base 51 is mounted in the hollow pull rod 33 and frictionally contacts the connecting shaft 41 to provide a resisting force against rotation of the connecting shaft 41. In this case, the base 51 includes two spaced-apart base walls 511, and a connecting wall 512 that interconnects the base walls 511 and that cooperates with the base walls 511 to define an open channel 513.

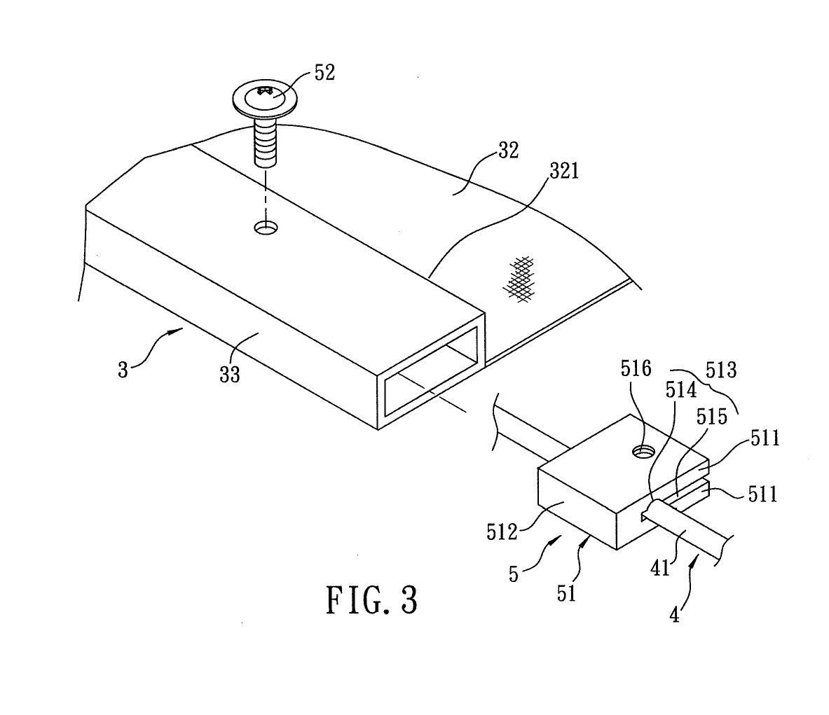

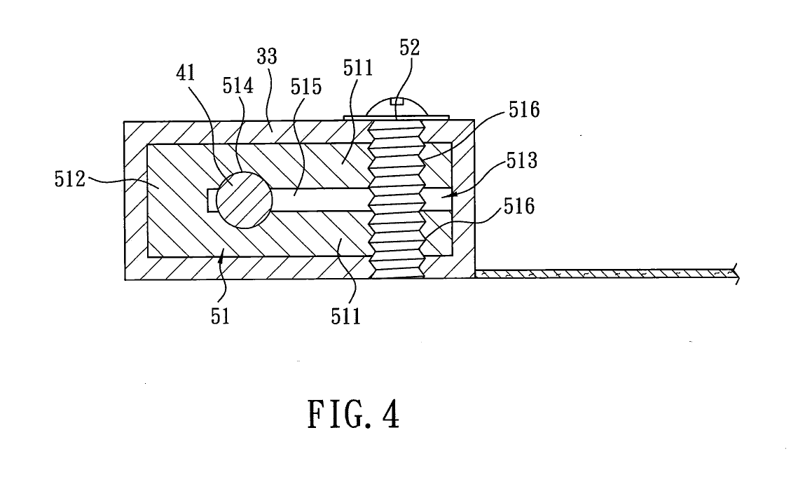

Referring to FIGS. 3 and 4, the open channel 513 has an insert portion 514 proximate to the connecting wall 512, and an open portion 515 distal from the connecting wall 512. Preferably, the insert portion 514 has a configuration substantially corresponding to that of the connecting shaft 41. The connecting shaft 41 is inserted through the insert portion 514. Moreover, the open portion 515 has a size narrower than that of the insert portion 514 such that the connecting rod 41 is limited in the insert portion 514 and sandwiched between the base walls 511. Each base wall 511 includes a threaded hole 516 that communicates with the open portion 515, and that is distal from the connecting wall 512.

The fastener 52 secures the base 51 to the pull rod 33. In this embodiment, the fastener 52 is configured as a bolt that extends through the pull rod 33 and that engages threadedly with the threaded holes 516 in the base walls 511 for securing the base 51 to the pull rod 33. In actual implementation, the number of the fastener 52 may be increased.

In this embodiment, the distance of the connecting wall 512 from the end 321 of the sunshade curtain 32 is longer than that of the fastener 52 that engages threadedly the base walls 511 from the end 321 of the sunshade curtain 32. Alternatively, the distance of the connecting wall 512 from the end 321 of the sunshade curtain 32 may be shorter than that of the fastener 52 that engages threadedly the base walls 511 from the end 321 of the sunshade curtain 32. Besides, the base 51 may be disposed outside the pull rod 33 in other embodiments.

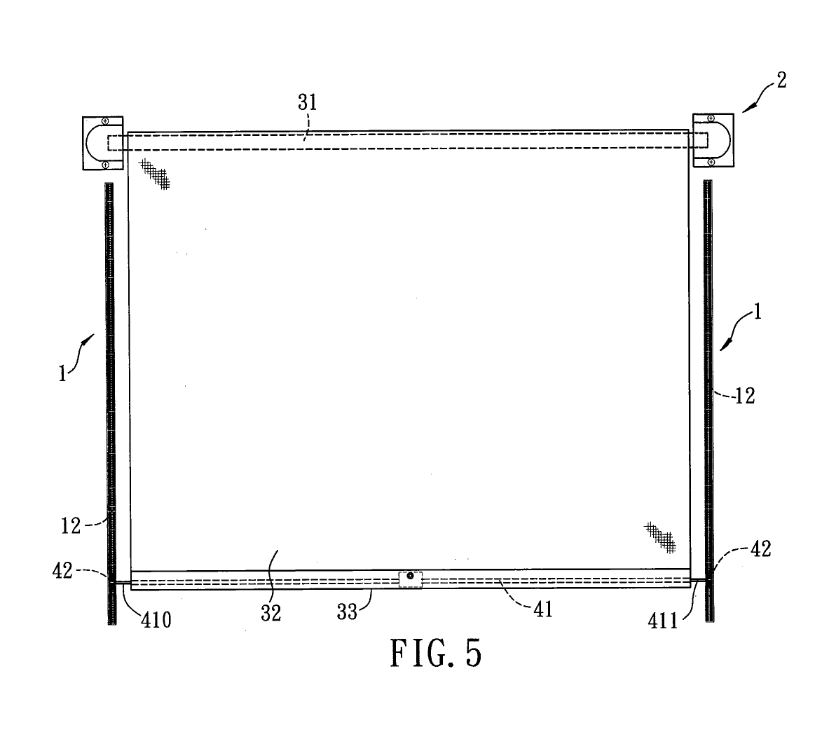

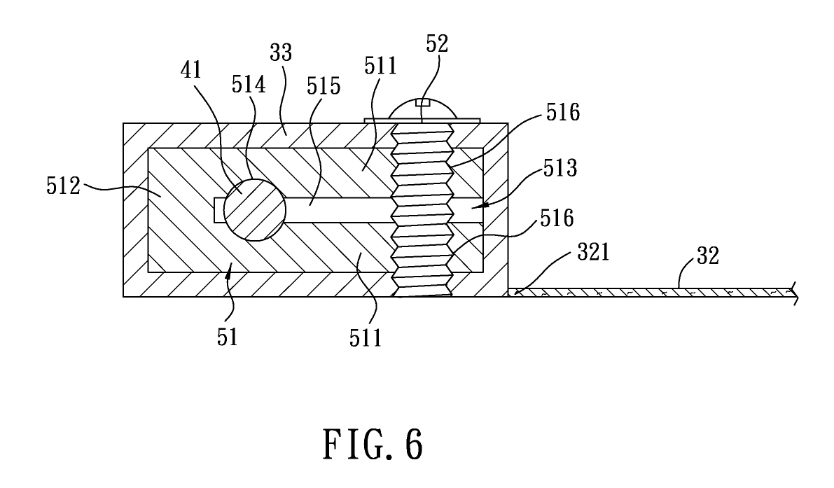

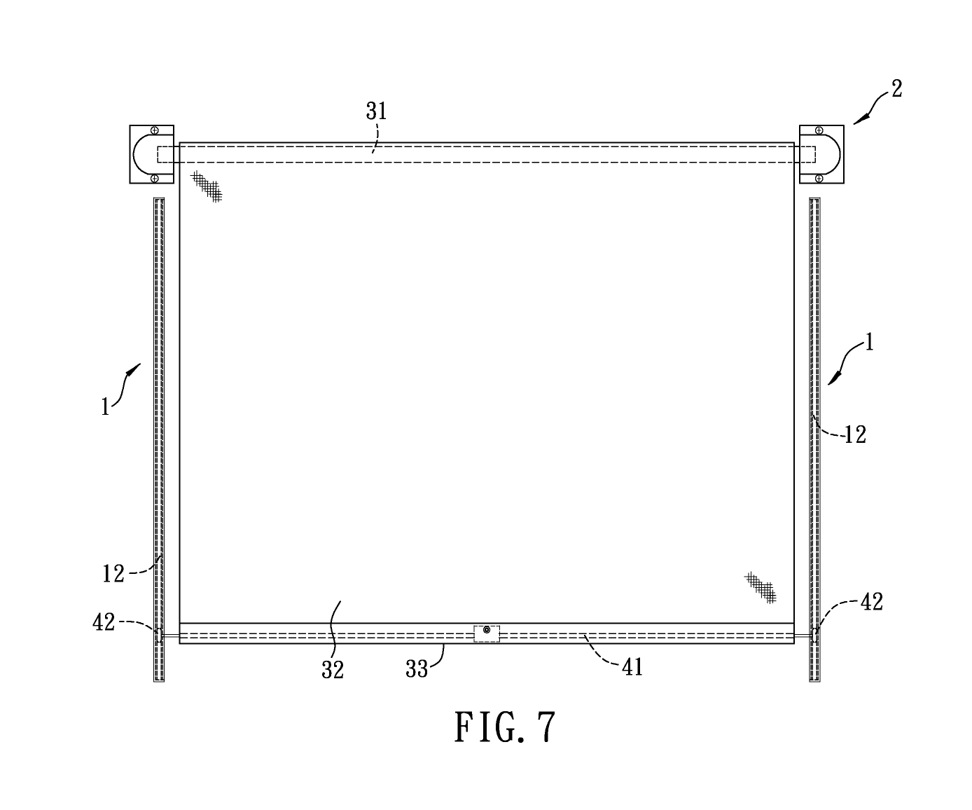

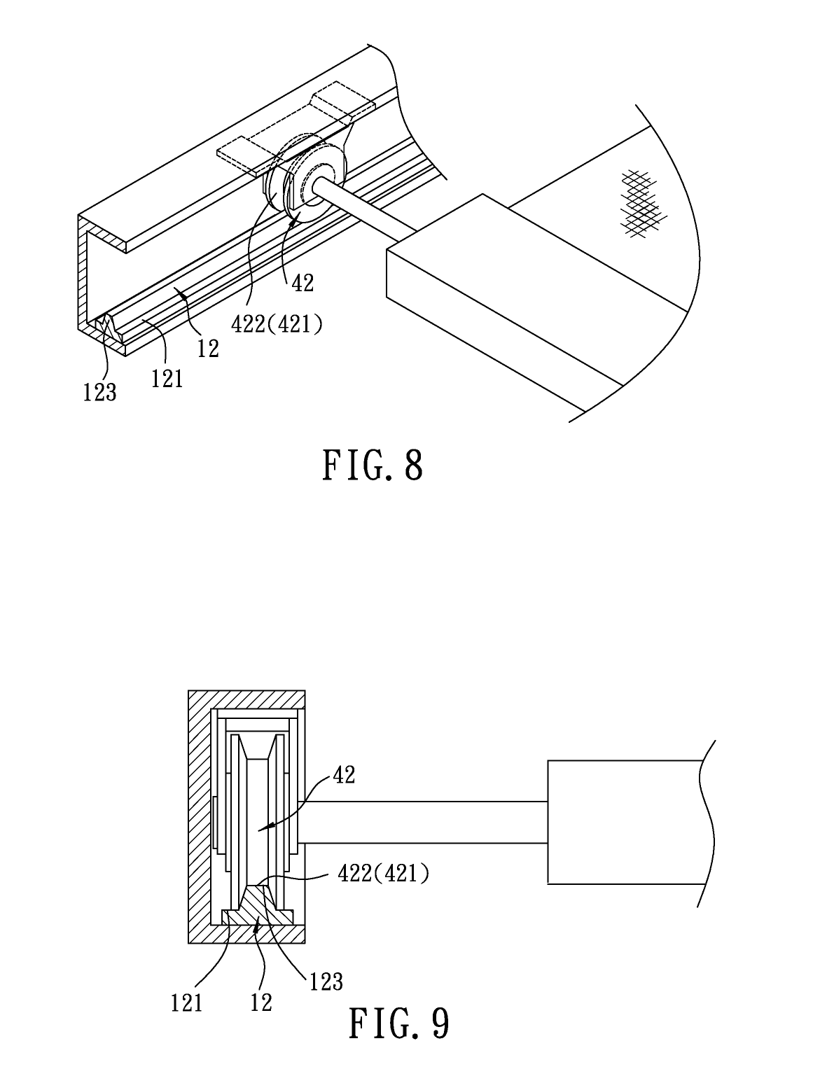

In use, the pull rod 33 can be pushed or pulled relative to the winding shaft 31. Therefore, the sunshade curtain 32 can be extended or retracted relative to the winding shaft 31 between an extended position shown in FIG. 5 and a take-up position shown in FIG. 1. After the sunshade assembly of this invention is assembled, the sunshade curtain 32 is at the take-up position. When the sunshade curtain 32 needs to be extended from the take-up position as shown in FIG. 1 to the extended position as shown in FIG. 5, the pull rod 33 is pulled to drive the connecting shaft 41 and the pinion gears 42 to move away from the winding shaft 31. Meanwhile, the sunshade curtain 32 can be extendably unwound between the guide rail units 1. When the sunshade curtain 32 needs to be retracted from the extended position as shown in FIG. 5 to the take-up position as shown in FIG. 1, the pull rod 33 is pushed to drive the connecting rod 41 and the pinion gears 42 to move towards the winding shaft 31, thereby winding the sunshade curtain 32 on the winding shaft 31.

During movement of the sunshade curtain 32, the pinion gears 42 rotate together with the connecting shaft 41 and move along the rack members 12. Since the connecting shaft 41 is connected to the pinion gears 42, even when a pull force does not act on a central portion of the pull rod 33, an engaging mechanism between each of the rack members 12 and the corresponding pinion gear 42 provides a stable and synchronous movement of each of the pinion gears 42 along the corresponding rack member 12 without swerving therefrom. Accordingly, the engaging mechanism assures that the pull rod 33 smoothly and stably moves between the guide rail units 1 along a direction away from or toward the winding shaft 31. The engaging mechanism can avoid the pull rod 33 from extending obliquely that would result in impeding movement or being stuck between the guide rail units 1. Therefore, the sunshade curtain 32 can be smoothly wound or unwound between the take-up and extended positions when being operated.

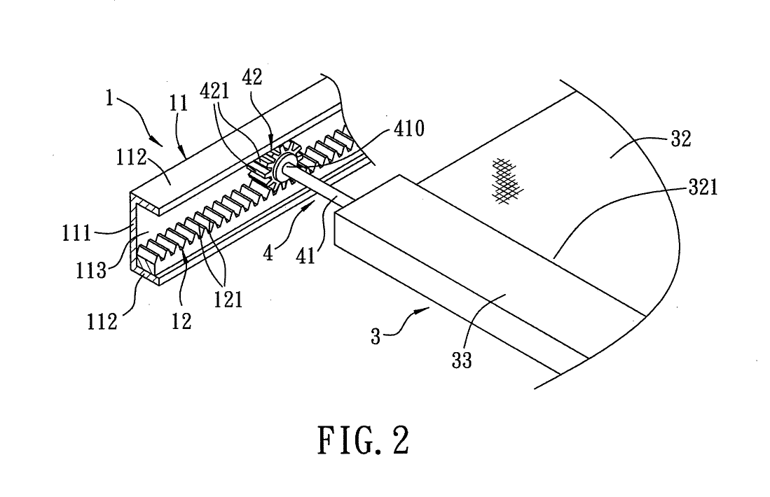

Specifically, referring FIGS. 1, 2, and 3, the connecting shaft 41 is inserted in the base 51 and frictionally contacts the base walls 511. After the fastener 52 engages threadedly with the base walls 511, the connecting shaft 41 is clamped between the base walls 511. Hence, during movement of the pull rod 33, the friction resistance force between the connecting shaft 41 and the base walls 511 has to be overcome so that the connecting shaft 41 is able to be concomitantly rotated with the pinion gears 42. When the sunshade curtain 32 is extended to any desired extended position by pulling at the pull rod 33, after the pull rod 33 is released, the pull rod 33 is stopped together with the sunshade curtain 32 at the desired extended position because a retracting force of the winding shaft 31 is less than the friction resistance force between the connecting rod 41 and the base walls 511, thereby achieving the pull and stop function with relative ease. In addition, referring to FIGS. 2 and 5, the engagement between the gear teeth 421 of each pinion gear 42 and the rack teeth 121 of the corresponding rack member 12 may also produce a retarding force against the retracting force of the winding shaft 31, so that the sunshade curtain 32 may be maintained at any desired extended position.

To sum up, by virtue of the engagement design of each of the rack members 12 and the corresponding pinion gear 42, the connecting shaft 41 connected to the pinion gears 42 can be smoothly moved and make the pinion gears 42 simultaneously rotate so as to prevent the pinion gears 42 from being stuck on the rack members 12 due to a noncentral pulling force. Therefore, the sunshade curtain 32 can be smoothly retracted and extended, thereby increasing convenience to users. Furthermore, according to a design of the resistance unit 5, the base 51 provides the connecting shaft 41 with the resisting force so that the pull rod 33 can be stopped immediately when the pulling or pushing force is released and so that the sunshade curtain 32 can be pulled and stopped at any desired extended position.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade assembly, comprising:
two spaced-apart mounting seats;
a winding shaft mounted rotatably between said mounting seats;
a sunshade curtain extendably wound around said winding shaft;
a pull rod connected to one end of said sunshade curtain that is distal from said winding shaft;
two guide rail units, each of which includes a longitudinal rack member extending in a direction transverse to said winding shaft;
a link unit including a connecting shaft mounted rotatably to said pull rod and having two opposite ends, and two pinion gears respectively attached to said two opposite ends of said connecting shaft and meshed with said rack members of said guide rail units; and
a resistance unit including a base mounted to said pull rod and frictionally contacting said connecting shaft to provide a resisting force against rotation of said connecting shaft.

2. The sunshade assembly as claimed in claim 1, wherein each of said rack members has a plurality of rack teeth, each of said pinion gears having a plurality of gear teeth respectively meshing with said rack teeth, said pinion gears rotating together with said connecting shaft and moving along said rack members.

3. The sunshade assembly as claimed in claim 1, wherein said base includes two spaced-apart base walls, and a connecting wall that interconnects said base walls and that cooperates with said base walls to define an open channel, said open channel having an insert portion proximate to said connecting wall, and an open portion distal from said connecting wall.

4. The sunshade assembly as claimed in claim 3, wherein said pull rod is a hollow rod, said resistance unit being disposed inside said hollow rod, said resistance unit further including a fastener to secure said base to said pull rod, said fastener being configured as a bolt that extends through said pull rod and that engages threadedly said base walls at portions distal from said connecting wall.
